(19) United States
(12) Patent Application Publication
(10) Pub. No.: US 2025/0079488 A1
(43) Pub. Date: Mar. 6, 2025

(54) FUEL CELL SYSTEM

(71) Applicant: TOYOTA JIDOSHA KABUSHIKI KAISHA, Toyota-shi, Aichi-ken (JP)

(72) Inventor: Daisuke SATOYA, Nisshin-shi, Aichi-ken (JP)

(73) Assignee: TOYOTA JIDOSHA KABUSHIKI KAISHA, Toyota-shi, Aichi-ken (JP)

(21) Appl. No.: 18/734,134

(22) Filed: Jun. 5, 2024

(30) Foreign Application Priority Data
Aug. 30, 2023 (JP) 2023-139773

(51) Int. Cl. H01M 8/04746; H01M 8/04082; H01M 8/0432

(52) U.S. Cl. CPC H01M 8/04753; H01M 8/04201; H01M 8/04328

(57) ABSTRACT

A stack unit including a fuel cell stack and a hydrogen tank module are provided. The hydrogen tank module includes a plurality of hydrogen tanks each provided with a valve, a temperature sensor for measuring the temperature of the hydrogen gas supplied from each hydrogen tank to the stack unit, and a control device for switching the supply state of the hydrogen gas from each hydrogen tank to the stack unit by controlling the valve of each hydrogen tank. The control device selectively uses one of the hydrogen tanks as a current supply tank for supplying the hydrogen gas to the stack unit, and switches the current supply tank to another hydrogen tank when a hydrogen gas temperature measured by the temperature sensor becomes equal to or lower than a reference temperature.

### CROSS-REFERENCE TO RELATED APPLICATION

This application claims priority to Japanese Patent Application No. 2023-139773 filed on Aug. 30, 2023, incorporated herein by reference in its entirety.

### BACKGROUND

### 1. Technical Field

The present disclosure relates to a fuel cell system.

### 2. Description of Related Art

Conventionally, there is known a fuel cell system that supplies hydrogen gas from a plurality of hydrogen tanks to a fuel cell stack (e.g., Japanese Unexamined Patent Application Publication No. 2018-113154 (JP 2018-113154 A)).

### SUMMARY

However, the inventor of the present disclosure has found that when valves of multiple hydrogen tanks are opened or closed at the same time, in-tank temperature of all the hydrogen tanks decreases in accordance with hydrogen consumption. Further, the inventor of the present disclosure has found that components used at supply destinations of hydrogen gas may be excessively cooled by the hydrogen gas, leading to problems occurring in the components. Accordingly, supplying hydrogen gas without excessively cooling the components at the supply destinations of the hydrogen gas is desired.

(1) According to an aspect of the present disclosure, a fuel cell system is provided. This fuel cell system includes a stack unit including a fuel cell stack, and a hydrogen tank module. The hydrogen tank module includes a plurality of hydrogen tanks, each provided with a valve, a temperature sensor for measuring temperature of hydrogen gas supplied to the stack unit from each hydrogen tank, and a control device for switching a supply state of the hydrogen gas from each hydrogen tank to the stack unit, by controlling the valve of each hydrogen tank. The control device selectively uses one of the hydrogen tanks as a current supply tank for supplying the hydrogen gas to the stack unit, and switches the current supply tank to another hydrogen tank when a hydrogen gas temperature measured by the temperature sensor becomes equal to or lower than a reference temperature. According to this fuel cell system, the current supply tank is switched when the temperature of the hydrogen gas supplied to the stack unit becomes equal to or lower than the reference temperature, and thus the hydrogen gas can be suppressed from excessively cooling the components of the stack unit.

(2) In the fuel cell system, the hydrogen tanks may be provided in parallel as to a hydrogen outlet of the hydrogen tank module, each hydrogen tank may be provided with an in-tank temperature sensor for measuring temperature in each hydrogen tank, as the temperature sensor, and the control device may select one of the hydrogen tanks in descending order of in-tank temperature, and sequentially use the selected one of the hydrogen tanks as the current supply tank. According to this fuel cell system, when the hydrogen tanks are provided in parallel, the tanks are used as the current supply tanks in descending order of the in-tank temperature, which enables frequent switching of the current supply tanks to be suppressed.

(3) In the fuel cell system, the hydrogen tanks may be provided in series as to a hydrogen outlet of the hydrogen tank module, and the control device may select one of the hydrogen tanks in order of closeness to the hydrogen outlet, and sequentially use the selected one of the hydrogen tanks as the current supply tank. According to this fuel cell system, when the hydrogen tanks are provided in series, the tanks are used as the current supply tanks in order of closeness to the hydrogen outlet, which enables sudden decrease in temperature of the hydrogen gas to be suppressed and frequent switching of the current supply tanks to be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a configuration of a fuel cell system;

FIG. 2 is an explanatory view showing a configuration of a hydrogen tank module according to the first embodiment;

FIG. 3 is a timing chart showing an example of valve control of the hydrogen tank module according to the first embodiment;

FIG. 4 is an explanatory view showing a configuration of a hydrogen tank module according to a second embodiment;

FIG. 5 is a timing chart showing an exemplary valve control of the hydrogen tank module according to the second embodiment; and

FIG. 6 is an explanatory diagram illustrating a configuration of a hydrogen tank module according to a third embodiment.

### DETAILED DESCRIPTION OF EMBODIMENTS

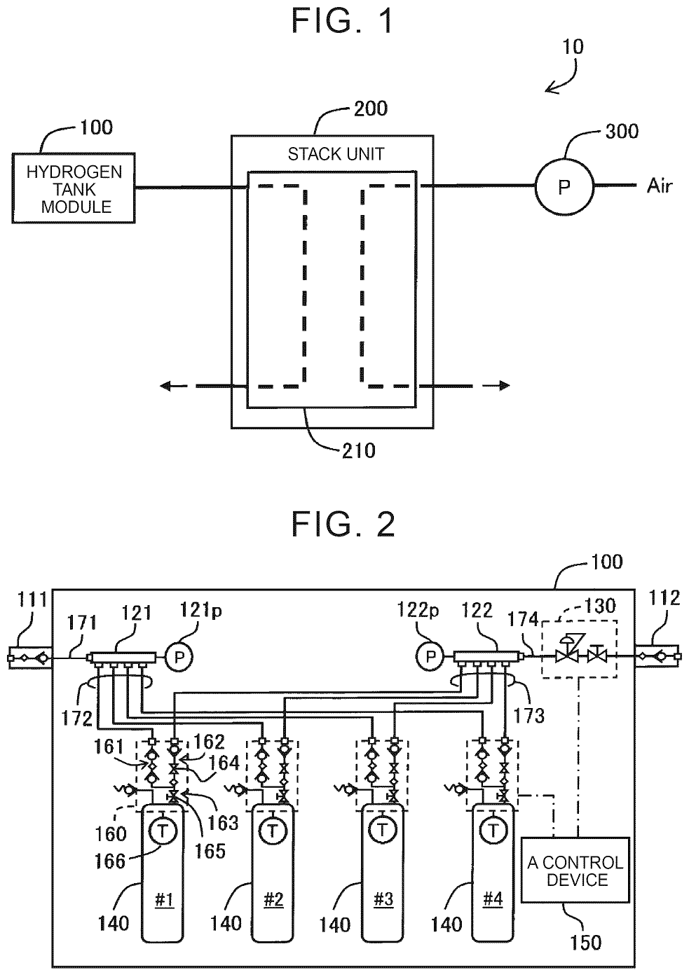

FIG. 1 is a conceptual diagram illustrating a configuration of a fuel cell system 10. The fuel cell system 10 includes an anode gas supply system including a hydrogen tank module 100, a stack unit 200 including a fuel cell stack 210, and a cathode gas supply system including an air compressor 300. The fuel cell stack 210 performs power generation by a fuel cell reaction between hydrogen gas supplied as an anode gas and oxygen supplied as a cathode gas. The anode gas supply system may include an injector and an anode exhaust gas circulation system. In addition, the cathode gas supply system may be configured to have various valves and flow dividing pipes.

FIG. 2 is an explanatory diagram illustrating a configuration of the hydrogen tank module 100 according to the first embodiment. The hydrogen tank module 100 includes a hydrogen inlet 111, a hydrogen outlet 112, an inflow-side connection portion 121, an outflow-side connection portion 122, a decompression unit 130, a plurality of hydrogen tanks 140, and a control device 150. Each hydrogen tank 140 is provided with a valve unit 160.

The hydrogen inlet 111 and the inflow-side connection portion 121 are connected by an inflow pipe 171. The inflow-side connection portion 121 is a branch connection portion including a plurality of branch ports, and each branch port is connected to a gas inlet of each valve unit 160 via a connection pipe 172. The outflow-side connection portion 122 is a collective connection including a plurality of inlets, and the individual inlets are connected to the gas outlets of the individual valve units 160 via connection pipes 173. The outflow-side connection portion 122 and the hydrogen outlet 112 are connected by an outflow pipe 174. A decompression unit 130 is provided in the middle of the outflow pipe 174. The decompression unit 130 includes a pressure reducing valve, and reduces the pressure of the hydrogen gas supplied to the hydrogen outlet 112 to a preset set pressure.

In the first embodiment, the plurality of hydrogen tanks 140 are connected in parallel to the hydrogen outlet 112 of the hydrogen tank module 100. Generally, the hydrogen tank module 100 is configured to include N hydrogen tanks 140. N is an integer of 2 or more, and N=4 in the first embodiment. Hereinafter, in order to distinguish the four hydrogen tanks 140 included in the hydrogen tank module 100, the tanks are referred to as “tank #1”, “tank #2”, “tank #3”, and “tank #4”, respectively.

The valve unit 160 includes an inflow pipe 161, an outflow pipe 162, and a common pipe 163. The inflow pipe 161 is connected to the gas inlet of the valve unit 160. The outflow pipe 162 is connected to the gas outlet of the valve unit 160. The common pipe 163 is connected to the inflow pipe 161 and the outflow pipe 162, and communicates with the inside of the hydrogen tank 140 via a base of the hydrogen tank 140. The inflow pipe 161 and the outflow pipe 162 are provided with a check valve and a filter, respectively. The common pipe 163 is provided with a solenoid valve 165, and the outflow pipe 162 is provided with an on-off valve 164.

The on-off valve 164 is a manual valve for maintenance, and is maintained in a normally open state when the hydrogen tank module 100 is used. The solenoid valve 165 is switched between an open state and a closed state by the control device 150 when the hydrogen tank module 100 is used. When the solenoid valve 165 is in the open state, the hydrogen gas in the hydrogen tank 140 flows out through the common pipe 163 and the outflow pipe 162. When the solenoid valve 165 is in the closed state, the outflow of the hydrogen gas in the hydrogen tank 140 is stopped. However, when the hydrogen gas is supplied to the gas inlet of the valve unit 160 in a state where the solenoid valve 165 is closed, the hydrogen gas is guided to the downstream side via the inflow pipe 161 and the outflow pipe 162. The latter property is utilized in the serial arrangement of the second embodiment described below.

The valve unit 160 further includes an in-tank temperature sensor 166 that measures the temperature of the hydrogen gas inside the hydrogen tank 140. The temperature measured by the in-tank temperature sensor 166 is referred to as “in-tank temperature”. The in-tank temperature sensor 166 is used as a temperature sensor for measuring the temperature of the hydrogen gas supplied from each hydrogen tank 140 to the stack unit 200. Instead of providing the in-tank temperature sensor 166 in each hydrogen tank 140, for example, a temperature sensor may be provided in the middle of the outflow pipe 174 to measure the temperature of the hydrogen gas supplied to the stack unit 200.

Pressure sensors 121p, 122p for measuring the pressure of the hydrogen gas are provided in each of the inflow-side connection portion 121 and the outflow-side connection portion 122. The decompression unit 130 may also be provided with a pressure sensor for measuring the pressure of the hydrogen gas before and after the pressure reduction. However, some of these pressure sensors may be omitted.

The control device 150 controls the operation of the hydrogen tank module 100 using the hydrogen gas temperature measured by the in-tank temperature sensor 166. Specifically, the control device 150 switches the supply state of the hydrogen gas from each hydrogen tank 140 to the stack unit 200 by controlling the opening and closing of the solenoid valves 165 of the valve units 160 provided in the respective hydrogen tanks 140. The term “valve” in the present disclosure means the solenoid valve 165 unless otherwise specified.

The hydrogen tank 140 used in the present embodiment is a so-called Type 4 tank, and is a high-pressure hydrogen container for FCV in which the working pressure is equal to or lower than 70 Mpa. When the hydrogen gas is continuously supplied from the hydrogen tank 140 to the stack unit 200, the supplied hydrogen gas temperature may decrease to about minus 40° C. On the other hand, the components used in the stack unit 200 have a large number of components whose lower limit of the operating temperature is in the range of minus 30° C. to minus 10° C., and if exposed to hydrogen gas having a temperature lower than this, there is a possibility that a defect may occur. Therefore, in the first embodiment, the control device 150 executes the valve control of the hydrogen tank module 100 so that the temperature of the hydrogen gas supplied from the hydrogen tank 140 is in a range higher than the use temperature lower limit of the components of the stack unit 200.

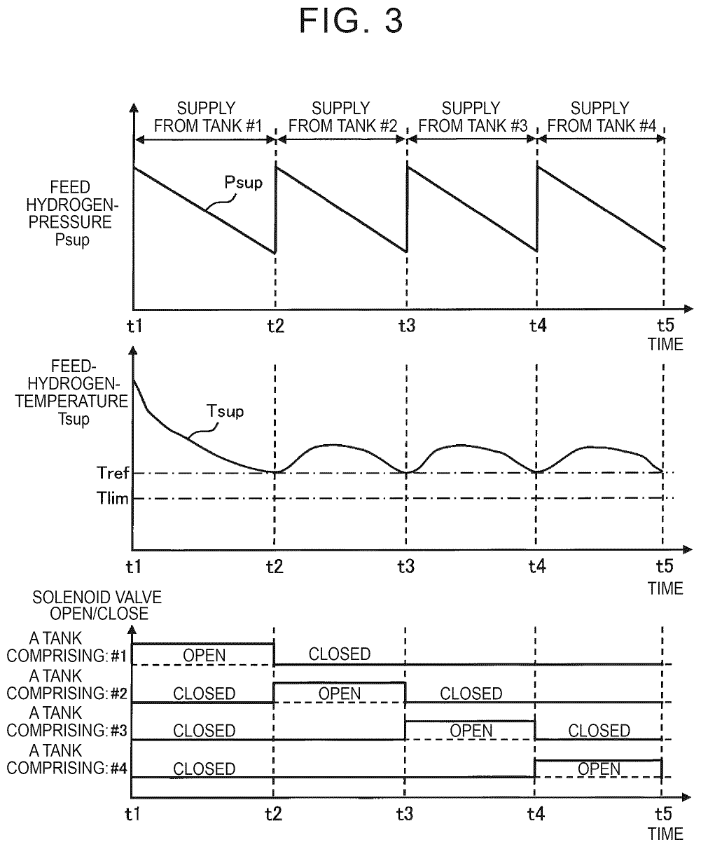

FIG. 3 is a timing chart illustrating an example of valve control of the hydrogen tank module 100 according to the first embodiment. FIG. 3 shows the supply hydrogen pressure Psup, the supply hydrogen temperature Tsup, and the opening and closing of the solenoid valves 165 of the four tanks #1 to #4. The supply hydrogen pressure Psup is the pressure of the hydrogen gas supplied from the individual hydrogen tanks 140 to the decompression unit 130. The supplied hydrogen temperature Tsup is the temperature of the hydrogen gas supplied from the individual hydrogen tanks 140 to the decompression unit 130. In one embodiment, the temperature in the tank of each hydrogen tank 140 measured by the in-tank temperature sensor 166 may be a supplied hydrogen temperature Tsup.

In the first embodiment, the control device 150 selects one of the hydrogen tanks 140 in descending order of the in-tank temperature and sequentially uses the selected one of the hydrogen tanks as the current supply tank. The “current supply tank” means a hydrogen tank in which the supply of hydrogen gas to the stack unit 200 is being performed. In FIG. 3, it is assumed that the tanks #1 to #4 is higher in in-tank temperature in this order. Preferably, the in-tank temperature uses a value measured at the start-up of the fuel cell system 10.

In the time t1 to t2 of FIG. 3, the tank #1 having the highest in-tank temperature among the tank #1 to #4 is selected and used as the current supply tank. During this time, the solenoid valve 165 of the tank #1 is open and the solenoid valve 165 of the other tank #2 to #4 is closed. The feed-hydrogen pressure Psup decreases monotonically from the initial pressure of tank #1. At time t2, the supplied-hydrogen temperature Tsup drops below a preset reference temperature Tref. The reference temperature Tref is preferably set to a value higher than the highest value Tlim among the lower limits of the operating temperatures of the plurality of components cooled by the hydrogen gas among the plurality of components of the stack unit 200.

At the time t2, the control device 150 switches the current supply tank from the tank #1 to the tank #2, and the supply hydrogen pressure Psup substantially increases to the initial pressure of the tank #2 in response to the switching. The feed-hydrogen-temperature Tsup also rises slightly at time t2 and then falls back. During the time t2 to t3, the solenoid valve 165 of the tank #2 is open, and the solenoid valves 165 of the other tanks #1, #3, and #4 are closed. However, the solenoid valve 165 of the tank #1 used as the current supply tank at first may be maintained open. This is because, during the time t2 to t3, the pressure of the tank #2 is higher than that of the tank #1, and therefore, even if the solenoid valve 165 of the tank #1 is open, substantially only the tank #2 serves as the current supply tank. Further, since the check valve is provided in the outflow pipe 162 of the valve unit 160, there is no fear that the hydrogen gas flows into the tank #1 even when the solenoid valve 165 of the tank #1 is opened. The feed-hydrogen-pressure Psup diminishes monotonically from the time t2. At time t3, the supplied-hydrogen temperature Tsup drops below the reference temperature Tref.

During time t3 to t4, tank #3 is used as the current supply tank. During time t4 to t5, tank #4 is used as the current supply tank. Since the operation in these periods is substantially the same as the operation in the period of time t2 to t3, the explanation will be omitted.

As described above, in the first embodiment, the current supply tank can be switched when the temperature of the hydrogen gas supplied to the stack unit 200 becomes equal to or lower than the reference temperature Tref. Therefore, it is possible to prevent the hydrogen gas from excessively cooling the components of the stack unit 200.

In the first embodiment, one of the hydrogen tanks 140 is selected in descending order of the in-tank temperature and is sequentially used as the current supply tank. However, the order of selection is not limited to this, and any one of the hydrogen tanks 140 may be selected as the current supply tank. However, in a case where a plurality of hydrogen tanks 140 are provided in parallel, it is possible to suppress frequent switching of the current supply tanks by using the tanks as the current supply tanks in descending order of the in-tank temperature. In addition, since it is estimated that the remaining amount of hydrogen gas is larger as the in-tank temperature is higher, the plurality of hydrogen tanks 140 can be used without any bias if they are used as the current supply tanks in descending order of the in-tank temperature.

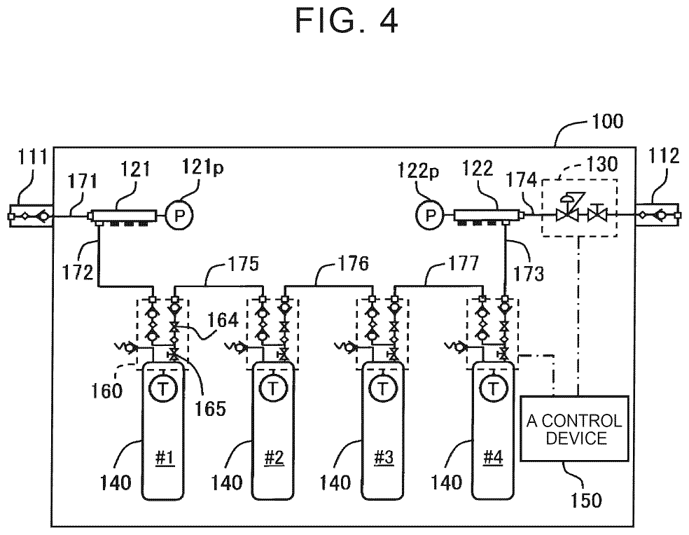

FIG. 4 is an explanatory diagram illustrating an internal configuration of the hydrogen tank module 100 according to the second embodiment. The configuration of the fuel cell system 10 according to the second embodiment is the same as that of the first embodiment. A difference between the second embodiment and the first embodiment is that a plurality of hydrogen tanks 140 of the hydrogen tank module 100 are provided in series with the hydrogen outlet 112. That is, the tank #1 is connected to the tank #2 via the connection pipe 175. Similarly, the tank #2 is connected to the tank #3 via the connection pipe 176, and the tank #3 is connected to the tank #4 via the connection pipe 177.

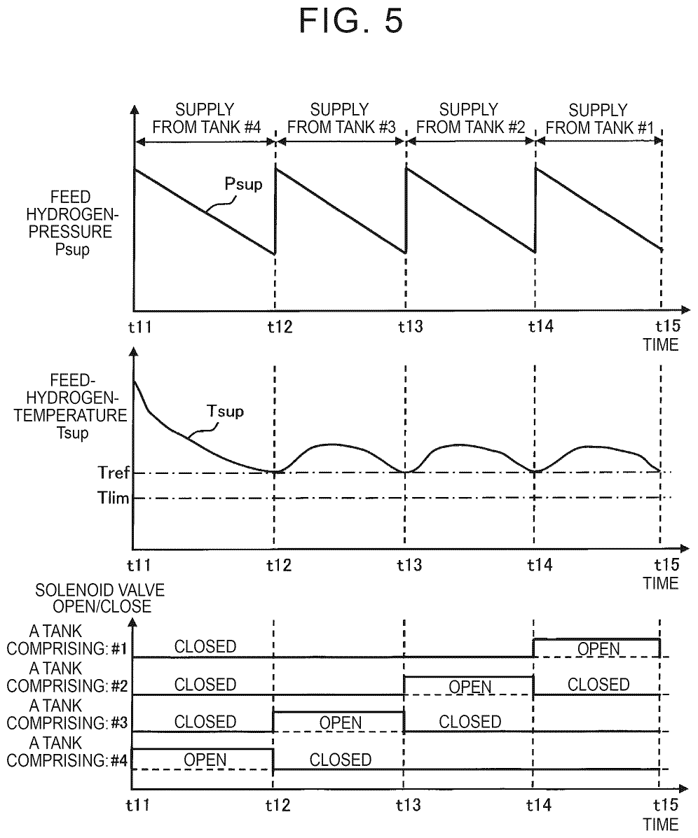

FIG. 5 is a timing chart illustrating an example of valve control of the hydrogen tank module 100 according to the second embodiment. In the second embodiment, the control device 150 selects one of the hydrogen tanks 140 in the order of being close to the hydrogen outlet 112, and sequentially uses the selected one of the hydrogen tanks as the current supply tank. By “close to the hydrogen outlet 112” is meant that it is located more downstream in the series hydrogen flow path. In the example of FIG. 4, the tanks #4, #3, #2, and #1 are closer to the hydrogen outlet 112 in this order.

In the time t11 to t12 of FIG. 5, the tank #4 closest to the hydrogen outlet 112 in the tank #1 to #4 is selected and used as the current supply tank. During this time, the solenoid valve 165 of the tank #4 is open and the solenoid valve 165 of the other tank #1 to #3 is closed. The changes in the supply hydrogen pressure Psup and the supply hydrogen temperature Tsup are substantially the same as those in the first embodiment shown in FIG. 3.

During time t12 to t13, tank #3 is used as the current supply tank. During time t13 to t14, tank #2 is used as the current supply tank. During time t14 to t15, tank #1 is used as the current supply tank.

In the second embodiment described above, similarly to the first embodiment, the current supply tank is switched when the temperature of the hydrogen gas supplied to the stack unit 200 becomes equal to or lower than the reference temperature Tref. Therefore, it is possible to prevent the hydrogen gas from excessively cooling the components of the stack unit 200. In addition, in the second embodiment, when a plurality of hydrogen tanks 140 are provided in series, they are used as the current supply tanks in order of being close to the hydrogen outlet 112. As a result, it is possible to suppress a sudden decrease in the temperature of the hydrogen gas and to suppress frequent switching of the current supply tank. Note that the order of selection of the hydrogen tank 140 in the second embodiment is not limited to this, and any one of the hydrogen tanks 140 may be selected as the current supply tank.

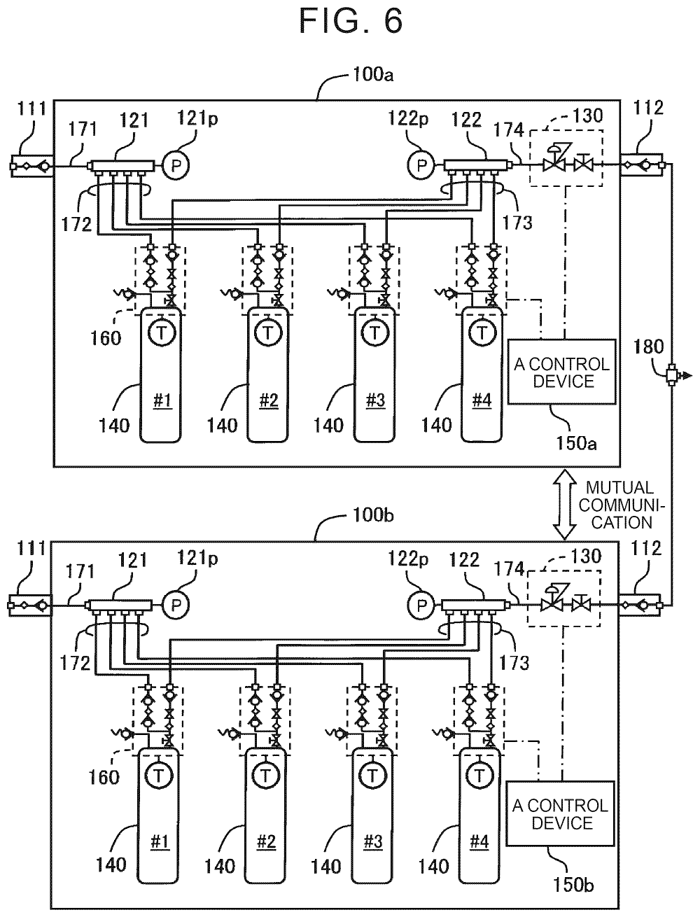

FIG. 6 is an explanatory diagram illustrating an internal configuration of the hydrogen tank module according to the third embodiment. In the third embodiment, two hydrogen tank modules 100 identical to those shown in FIG. 2 are connected in parallel and used. The hydrogen outlets 112 of the two hydrogen tank modules 100a, 100b are connected to a common hydrogen outlet 180. The hydrogen gas is supplied from the common hydrogen outlet 180 to the stack unit 200. The eight hydrogen tanks 140 included in the two hydrogen tank modules 100a, 100b are connected in parallel to the common hydrogen outlet 180.

The control devices 150a, 150b of the two hydrogen tank modules 100a, 100b are configured to be able to communicate with each other, and cooperatively function as a single control device. As in the first embodiment, the control devices 150a, 150b selects one of the hydrogen tanks 140 in descending order of the in-tank temperature and sequentially uses the selected one of the hydrogen tanks as the current supply tank. The valve control method according to the third embodiment is substantially the same as that of the first embodiment shown in FIG. 3, and thus description thereof will be omitted.

In the third embodiment, as in the first embodiment, the current supply tank is switched when the temperature of the hydrogen gas supplied to the stack unit 200 becomes equal to or lower than the reference temperature Tref. Therefore, it is possible to prevent the hydrogen gas from excessively cooling the components of the stack unit 200. In addition, in a case where a plurality of hydrogen tanks 140 are provided in parallel, since the tanks are used as the current supply tanks in descending order of the in-tank temperature, it is possible to suppress frequent switching of the current supply tanks.

In the above-described embodiments, the stack unit 200 is used as a hydrogen supply destination of the hydrogen tank module 100. However, the present disclosure is also applicable to a case where hydrogen is supplied to any supply destination apparatus other than the stack unit 200.

### Other Forms:

The present disclosure is not limited to the above-described embodiments, and can be realized in various forms without departing from the spirit thereof. For example, the present disclosure can also be realized by the following aspect. The technical features in the above-described embodiments corresponding to the technical features in the respective embodiments described below can be appropriately replaced or combined in order to solve some or all of the problems of the present disclosure or to achieve some or all of the effects of the present disclosure. When the technical features are not described as essential in this specification, the technical features can be deleted as appropriate.

The present disclosure can be realized in various forms other than a fuel cell system and a control method thereof. For example, the present disclosure can be realized in the form of a hydrogen tank module, a control method thereof, a computer program for executing control of a fuel cell system or a hydrogen tank module, a non-transitory storage medium in which a computer program is recorded, or the like.

What is claimed is:

1. A fuel cell system comprising:
a stack unit including a fuel cell stack; and
a hydrogen tank module, wherein
the hydrogen tank module includes
a plurality of hydrogen tanks, each provided with a valve,
a temperature sensor for measuring temperature of hydrogen gas supplied to the stack unit from each hydrogen tank, and
a control device for switching a supply state of the hydrogen gas from each hydrogen tank to the stack unit, by controlling the valve of each hydrogen tank, and
the control device selectively uses one of the hydrogen tanks as a current supply tank for supplying the hydrogen gas to the stack unit, and switches the current supply tank to another hydrogen tank when a hydrogen gas temperature measured by the temperature sensor becomes equal to or lower than a reference temperature.

2. The fuel cell system according to claim 1, wherein:
the hydrogen tanks are provided in parallel as to a hydrogen outlet of the hydrogen tank module;
each hydrogen tank is provided with an in-tank temperature sensor for measuring temperature in each hydrogen tank, as the temperature sensor; and
the control device selects one of the hydrogen tanks in descending order of in-tank temperature, and sequentially uses the selected one of the hydrogen tanks as the current supply tank.

3. The fuel cell system according to claim 1, wherein:
the hydrogen tanks are provided in series as to a hydrogen outlet of the hydrogen tank module; and
the control device selects one of the hydrogen tanks in order of closeness to the hydrogen outlet, and sequentially uses the selected one of the hydrogen tanks as the current supply tank.
